(19) United States
(12) Patent Application Publication
(10) Pub. No.: US 2014/0025965 A1
(43) Pub. Date: Jan. 23, 2014

(54) POWER DATA SWITCH COMMUNICATION ARCHITECTURE

(71) Applicants: Yu-Yuan Chang, New Taipei City (TW); Tsung-Chun Chen, New Taipei City (TW); Kuang-Lung Shih, New Taipei City (TW)

(72) Inventors: Yu-Yuan Chang, New Taipei City (TW); Tsung-Chun Chen, New Taipei City (TW); Kuang-Lung Shih, New Taipei City (TW)

(21) Appl. No.: 13/551,819

(22) Filed: Jul. 18, 2012

(51) Int. Cl. G06F 1/26

(52) U.S. Cl. 713/300

(57) ABSTRACT

A power data switch communication architecture includes a first power supply unit, a second power supply unit, a motherboard and a data communication switch unit. The first power supply unit and the second power supply unit include respectively a first power source management unit and a second power source management unit that generate respectively corresponding first and second working parameters based on operating states of the first and second power supply units. The motherboard includes a first data communication circuit connected to the first power source management unit and a second data communication circuit connected to the second power source management unit. The data communication switch unit is electrically connected to the first data communication circuit and the second data communication circuit to receive a switch signal to determine whether to set on the first data communication circuit or the second data communication circuit.

### FIELD OF THE INVENTION

The present invention relates to power data switch communication architecture and particularly to power data switch communication architecture for electronic apparatus equipped with power supply units.

### BACKGROUND OF THE INVENTION

Advance of computer technology has enabled computer systems to provide a wide variety of functions in response to users' requirements, such as data processing or recreational activities. They need to continuously process a huge amount of complex information, and require stable and great amount of power supply. To prevent abrupt power outage or surge caused by switching to backup power that might damage expensive and complex electronic apparatus and result in instant loss of processing information, advanced computer systems generally adopt N+M redundant power supply system to maintain normal operation without interrupting power supply. N represents the number of combined power supplies required to support the total power load value of the electronic apparatus, while M indicates the allowable number of dysfunctional power supplies. N≧1, and M≧1. A redundant power supply system includes N+M sets of power supplies. Each power supply includes a standby power unit to provide standby DC power and a main power unit to output DC power in a power on state. At present many types of redundant power supply systems have been developed to enhance backup or fault tolerance function. For instance, U.S. Pat. No. 7,394,674 provides a backup power supply with parallel AC power source and DC power source. It adopts a dual-power source input design to continuously supply DC power to electronic apparatus to maintain normal operation thereof when outage of any one power input source occurs.

Although adequate power can be provided by using the aforesaid N+M redundant power supply system in order to meet the requirement of increasing performances of computer system, a great amount of power sources is simultaneously consumed. Thus, the importance of power source management system has gained growing awareness, especially under the prevailing trend of green and eco-friendly technology. At present the most commonly adopted power source management systems include the Advanced Power Management (APM) and the Advanced Configuration and Power Interface (ACPI). The conventional APM is predominantly controlled by a firmware based on Basic Input/Output System (BIOS), under which the input of commands or decisions is difficult. Furthermore, the power cannot be adjusted effectively with changes of the operation system. The ACPI is a new power source management technique. Users can perform power source management through the operation system and can inspect power source consumption status. As the ACPI employs the operation system that extensively controls hardware to replace the conventional power source management through the BIOS, the power source management efficiency can be effectively improved. Moreover, power source management of the ACPI can be incorporated with hardware to register and control power loss status of many apparatus. The items being monitored are extensive, including the voltage of power supply, the temperature of motherboard and the rotational speed of air fans etc.

However, in the conventional computer system, one motherboard can only perform power source management for one power supply. Under the architecture of the N+M redundant power supply system, although power from the multiple power supplies can be sent to the motherboard through an integrated back panel to serve as driving power, the motherboard cannot effectively and thoroughly monitor the power information and power supplying status of the power supplies.

### SUMMARY OF THE INVENTION

The primary object of the present invention is to solve the problem of the conventional motherboard that cannot effectively monitor power information and power supplying status of each power supply in an N+M redundant power supply system. To achieve the foregoing object, the present invention provides a power data switch communication architecture located in an electronic apparatus. It includes a first power supply unit, a second power supply unit, a motherboard and a data communication switch unit. The first power supply unit includes a first power source management unit to generate at least one corresponding first working parameter based on operating states of the first power supply unit. The second power supply unit includes a second power source management unit to generate at least one corresponding second working parameter based on operating states of the second power supply unit. The motherboard includes a first data communication circuit connected to the first power source management unit to get the first working parameter, and a second data communication circuit connected to the second power source management unit to get the second working parameter. The data communication switch unit is electrically connected to the first data communication circuit and second data communication circuit to receive a switch signal to determine whether to set on the first data communication circuit or the second data communication circuit.

In one embodiment the data communication switch unit includes a first conduction unit in the first data communication circuit and a second conduction unit in the second data communication circuit.

In another embodiment the first data communication circuit includes a first serial data line and a first serial clock line.

In yet another embodiment the second data communication circuit includes a second serial data line and a second serial clock line.

In yet another embodiment the motherboard includes a first control circuit connected to the data communication switch unit to output the switch signal generated by the motherboard.

In yet another embodiment the electronic apparatus includes a switch operable for users to generate the corresponding switch signal. The switch includes a second control circuit connected to the data communication switch unit.

In yet another embodiment the first working parameter and the second working parameter are voltage values of DC power generated by the first and second power supply units.

In yet another embodiment the first power source management unit is electrically connected to a temperature detection unit, and the first working parameter is the interior temperature of the first power supply unit.

In yet another embodiment the second power source management unit is electrically connected to a temperature detection unit, and the second working parameter is the interior temperature of the second power supply unit.

In yet another embodiment the first power source management unit is electrically connected to a cooling fan, and the first working parameter is the rotational speed of the cooling fan.

In yet another embodiment the second power source management unit is electrically connected to a cooling fan, and the second working parameter is the rotational speed of the cooling fan.

In yet another embodiment the first power supply unit includes a rectification filter unit connected to an external power source, a power factor correction unit connected to the rectification filter unit, a transformer, a pulse width control unit, a switch element and a rectification output unit.

In yet another embodiment the second power supply unit includes a rectification filter unit connected to an external power source, a power factor correction unit connected to the rectification filter unit, a transformer, a pulse width control unit, a switch element and a rectification output unit.

In short, in the power data switch communication architecture of the invention, the motherboard is connected to the first data communication circuit of the first power source management unit and the second data communication circuit of the second power source management unit through a data communication switch unit which determines whether to set on the first data communication circuit or the second data communication circuit. Then, the motherboard can get the first working parameter or second working parameter through the set-on first data communication circuit or the set-on second data communication circuit, thereby the motherboard can effectively monitor power information or power supply status of the first power supply unit and second power supply unit.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is a circuit block diagram of a first embodiment of the power data switch communication architecture of the invention.

FIG. 2 is a circuit block diagram of a second embodiment of the power data switch communication architecture of the invention.

### DETAILED DESCRIPTION OF THE PREFERRED EMBODIMENTS

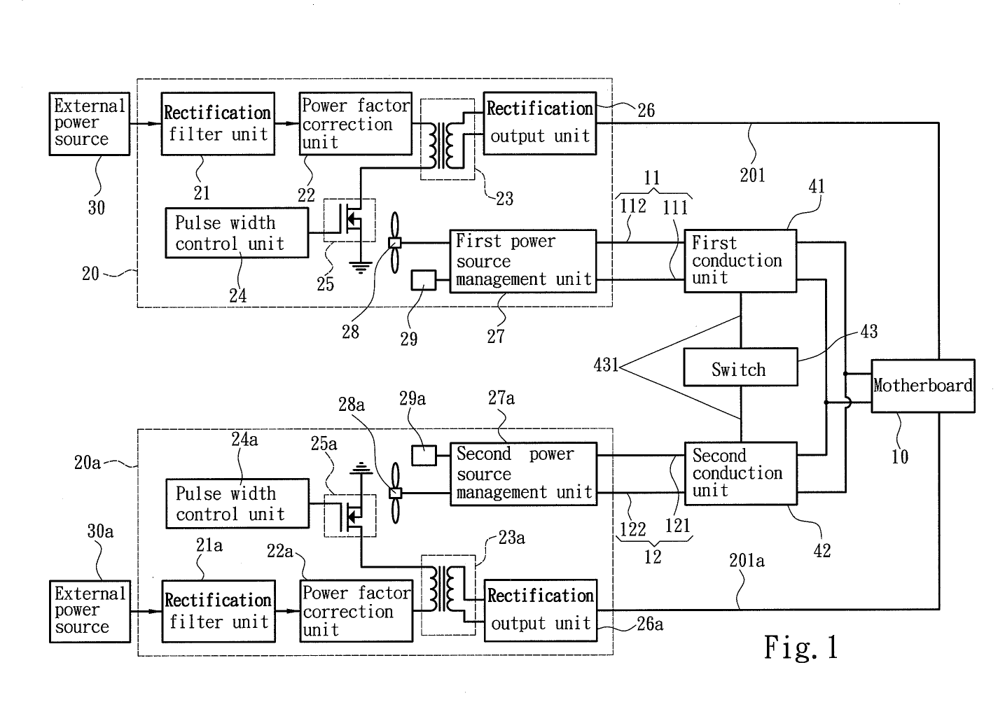

Please refer to FIG. 1 for the circuit block diagram of a first embodiment of the power data switch communication architecture of the invention. It is located in an electronic apparatus which is a computer system in this embodiment. The computer system includes at least one motherboard 10, and a first power supply unit 20 and a second power supply unit 20a to output DC power. The motherboard 10 includes at least a central processing unit (CPU) and other electronic elements and circuits. The first and second power supply units 20 and 20a can be combined to form an N+M redundant power supply system, where N represents the number of the first power supply unit 20, while M represents the number of the second power supply unit 20a, and N≧1 and M≧1. In this embodiment N=1 and M=1. The first and second power supply units 20 and 20a include respectively a rectification filter unit 21 and 21a connected to an external power source 30 and 30a, a power factor correction unit 22 and 22a connected to the rectification filter unit 21 and 21a, a transformer 23 and 23a, a pulse width control unit 24 and 24a, a switch element 25 and 25a, and a rectification output unit 26 and 26a. The external power sources 30 and 30a output external AC power which passes through the rectification filter units 21 and 21a and power factor correction units 22 and 22a. The power factor correction units 22 and 22a regulate the power factor and voltage of the external power by a voltage transformation power level. The pulse width control units 24 and 24a determine the duty cycle of the switch elements 25 and 25a, thereby regulate the coil current passing through the transformers 23 and 23a. Finally, the rectification output units 26 and 26a generate DC power 201 and 201a respectively and transmit the DC power 201 and 201a to the motherboard 10. Moreover, the first and second power supply units 20 and 20a can be electrically connected to at least one power integration control unit (not shown in the drawings) simultaneously. The first and second power supply units 20 and 20a also contain respectively at least one cooling fan 28 and 28a and one temperature detection unit 29 and 29a.

The first power supply unit 20 includes a first power source management unit 27 which generates at least one corresponding first working parameter based on operating states of the first power supply unit 20. The second power supply unit 20a includes a second power source management unit 27a which generates at least one corresponding second working parameter based on operating states of the second power supply unit 20a. The first and second working parameters can be voltage values of the DC power 201 and 201a, the interior temperature of the first and second power supply units 20 and 20a, or the rotational speeds of the cooling fans 28 and 28a.

The motherboard 10 includes a first data communication circuit 11 connected to the first power source management unit 27 to get the first working parameter, and a second data communication circuit 12 connected to the second power source management unit 27a to get the second working parameter. In this invention the first data communication circuit 11 and the second data communication circuit 12 are electrically connected to a data communication switch unit. The data communication switch unit includes a first conduction unit 41 located in the first data communication circuit 11 and a second conduction unit 42 located in the second data communication circuit 12. The first conduction unit 41 and the second conduction unit 42 are connected to a switch 43. The switch 43 includes a second control circuit 431 connected to the first conduction unit 41 and the second conduction unit 42. By operating the switch 43, a switch signal can be generated to control the first conduction unit 41 or the second conduction unit 42 to determine whether to set on the first data communication circuit 11 or the second data communication circuit 12. In this embodiment the switch 43 has at least one switch position corresponding to the first power supply unit 20 and the second power supply unit 20a. When the switch 43 is adjusted to different switch positions, corresponding switch signals are outputted. When a user intends to monitor or manage the first power supply unit 20 through the motherboard 10, he/she can maneuver the switch 43 to a switch position corresponding to the first power supply unit 20, then the switch 43 outputs a switch signal to the first conduction unit 41 to set on the first data communication circuit 11. Thus, the motherboard 10 can get the first working parameter of the first power supply unit 20 through the first data communication circuit 11, and the CPU can perform power source management to the first power supply unit 20. On the other hand, when the user intends to monitor or manage the second power supply unit 20a through the motherboard 10, he/she also can maneuver the switch 43 to another switch position corresponding to the second power supply unit 20a, then the switch 43 outputs a switch signal to the second conduction unit 42 to set on the second data communication circuit 12. Thus, the motherboard 10 can get the second working parameter of the second power supply unit 20a through the second data communication circuit 12 and perform power source management to the second power supply unit 20a.

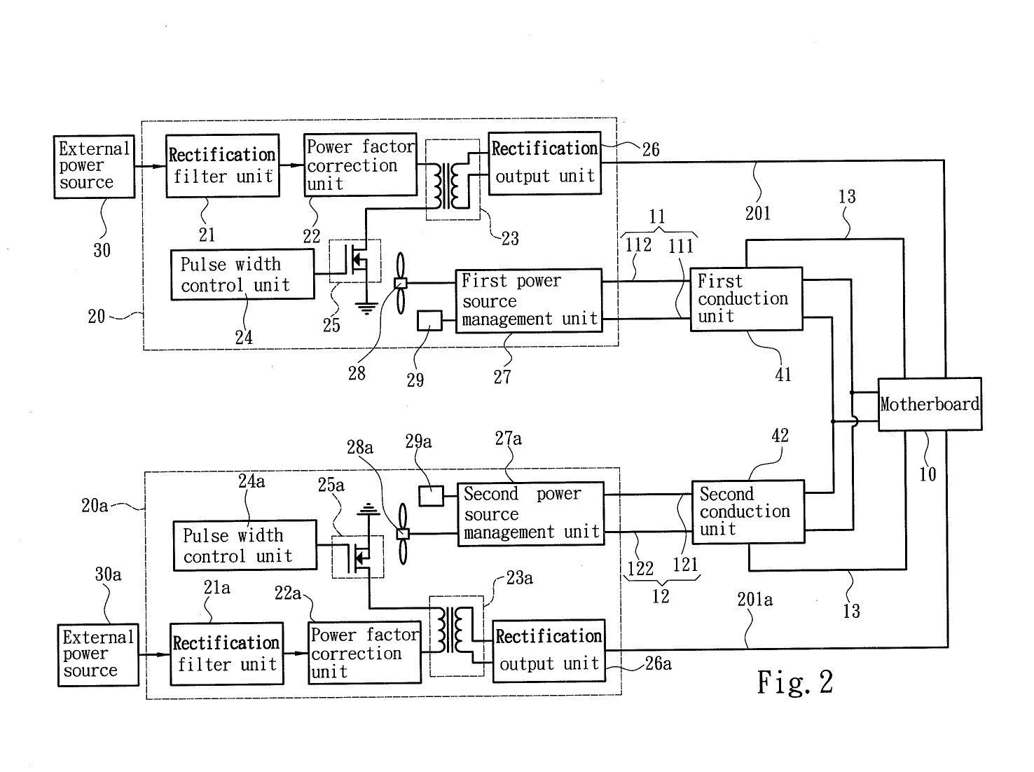

In the aforesaid embodiment, the switch 43 drives the data communication switch unit to set on either the first conduction unit 41 or second conduction unit 42. In addition, the invention can also achieve the same effect through software. Please refer to FIG. 2 for the circuit block diagram of another embodiment of the invention. The motherboard 10 includes a first control circuit 13 connected to the first conduction unit 41 and the second conduction unit 42. When the user intends to monitor or manage the first power supply unit 20 through the motherboard 10, he/she can use the software of the electronic apparatus to control the motherboard 10 to generate a corresponding switch signal to the first conduction unit 41 to set on the first data communication circuit 11. Thus, the motherboard 10 can get the first working parameter of the first power supply unit 20 through the first data communication circuit 11. When the user intends to monitor or manage the second power supply unit 20a, he/she also can use the software of the electronic apparatus to control the motherboard 10 to generate another corresponding switch signal to the second conduction unit 42 to set on the second data communication circuit 12. Thus, the motherboard 10 can get the second working parameter of the second power supply unit 20a through the second data communication circuit 12.

In this embodiment the first and second power supply units 20 and 20a and the motherboard 10 are connected via an internal integrated circuit (Inter-Integrated Circuit, I²C) bus. The first data communication circuit 11 includes a first serial data line 111 and a first serial clock line 112, and the second data communication circuit 12 includes a second serial data line 121 and a second serial clock line 122. The first serial data line 111 and second serial data line 121 transmit data and address in a two-way fashion. The first serial clock lines 112 and second serial clock line 122 transmit clock in a two-way fashion.

In short, in the power data switch communication architecture of the invention, the motherboard is connected respectively to a first data communication circuit of the first power source management unit and a second data communication circuit of the second power source management unit through a data communication switch unit that determines whether to set on the first data communication circuit or the second data communication circuit. Thus, the motherboard can get the first working parameter or the second working parameter through the set-on first data communication circuit or the set-on second data communication circuit to perform power source management. As a result, the motherboard can effectively monitor power information or power supply status of the first power supply unit and second power supply unit.

While the preferred embodiments of the invention have been set forth for the purpose of disclosure, they are not the limitations of the invention. Modifications of the disclosed embodiments of the invention as well as other embodiments thereof may occur to those skilled in the art. Accordingly, the appended claims are intended to cover all embodiments which do not depart from the spirit and scope of the invention.

What is claimed is:

1. A power data switch communication architecture located in an electronic apparatus, comprising:
a first power supply unit including a first power source management unit to generate at least one corresponding first working parameter based on operating states of the first power supply unit;
a second power supply unit including a second power source management unit to generate at least one corresponding second working parameter based on operating states of the second power supply unit;
a motherboard including a first data communication circuit connected to the first power source management unit to get the at least one first working parameter and a second data communication circuit connected to the second power source management unit to get the at least one second working parameter; and
a data communication switch unit which is electrically connected to the first data communication circuit and the second data communication circuit to receive a switch signal to determine whether to set on the first data communication circuit or the second data communication circuit.

2. The power data switch communication architecture of claim 1, wherein the data communication switch unit includes a first conduction unit located in the first data communication circuit and a second conduction unit located in the second data communication circuit.

3. The power data switch communication architecture of claim 1, wherein the first data communication circuit includes a first serial data line and a first serial clock line.

4. The power data switch communication architecture of claim 1, wherein the second data communication circuit includes a second serial data line and a second serial clock line.

5. The power data switch communication architecture of claim 1, wherein the motherboard includes a first control circuit connected to the data communication switch unit to output the switch signal generated by the motherboard.

6. The power data switch communication architecture of claim 1, wherein the electronic apparatus includes a switch operable for users to generate the corresponding switch signal, the switch including a second control circuit connected to the data communication switch unit.

7. The power data switch communication architecture of claim 1, wherein the at least one first working parameter and the at least one second working parameter are voltage values of DC power generated by the first power supply unit and the second power supply unit.

8. The power data switch communication architecture of claim 1, wherein the first power source management unit is electrically connected to a temperature detection unit, the at least one first working parameter being an interior temperature of the first power supply unit.

9. The power data switch communication architecture of claim 1, wherein the second power source management unit is electrically connected to a temperature detection unit, the at least one second working parameter being an interior temperature of the second power supply unit.

10. The power data switch communication architecture of claim 1, wherein the first power source management unit is electrically connected to a cooling fan, the at least one first working parameter being a rotational speed of the cooling fan.

11. The power data switch communication architecture of claim 1, wherein the second power source management unit is electrically connected to a cooling fan, the at least one second working parameter being a rotational speed of the cooling fan.

12. The power data switch communication architecture of claim 1, wherein the first power supply unit includes a rectification filter unit connected to an external power source, a power factor correction unit connected to the rectification filter unit, a transformer, a pulse width control unit, a switch element and a rectification output unit.

13. The power data switch communication architecture of claim 1, wherein the second power supply unit includes a rectification filter unit connected to an external power source, a power factor correction unit connected to the rectification filter unit, a transformer, a pulse width control unit, a switch element and a rectification output unit.
